(19) United States
(12) Patent Application Publication
(10) Pub. No.: US 2008/0171068 A1
(43) Pub. Date: Jul. 17, 2008

(54) ANTIMICROBIAL, INFECTION-CONTROL AND ODOR-CONTROL FILM AND FILM COMPOSITE

(75) Inventors: Daniel M. Wyner, North Scituate, RI (US); Marc D. Etchells, Westhampton, MA (US); Paul A. Darby, Amherst, MA (US)

Correspondence Address: BARLOW, JOSEPHS & HOLMES, LTD., 101 DYER STREET, 5TH FLOOR, PROVIDENCE, RI, 02903, US

(73) Assignee: ETCETERA LLC, Greenfield, MA (US)

(21) Appl. No.: 12/013,766

(22) Filed: Jan. 14, 2008

Related U.S. Application Data
(60) Provisional application No. 60/885,275, filed on Jan. 17, 2007.

(51) Int. Cl. A01N 25/10; A01N 25/34

(52) U.S. Cl. 424/404; 424/409

(57) ABSTRACT

A novel method of producing an odor-controlling textile is disclosed. More specifically, a textile structure is disclosed that contains thin breathable film layer having an activatable antimicrobial odor controlling material. Most specifically, the present invention relates to a textile composite that is composed of a flexible breathable film layer with a measurable gas or vapor transmission rate, that contains metallic silver, zinc and/or copper metallic ions, and is combined with fabric and/or foam layers to form an antimicrobial, odor and infection control laminated structure.

### CROSS-REFERENCE TO RELATED APPLICATIONS

This application is related to and claims priority from earlier filed U.S. Provisional Patent Application No. 60/885,275, filed Jan. 17, 2007.

### BACKGROUND OF THE INVENTION

The present invention relates generally to the field of odor-control materials. More specifically, the present invention relates to antimicrobial materials and methods of adding these antimicrobial materials to a flexible breathable textile and/or foam composite.

Without limiting the scope of the invention, its background is described generally in connection with antimicrobial and odor-control “actives” that are incorporated into breathable polymeric films and/or adhesives and composites containing those films and/or adhesives. The present invention furthermore generally relates to textiles that contain an antimicrobial formulation used to control the growth of bacteria and inhibit odors. More specifically, this invention relates to the use of antimicrobial formulations that are incorporated into a thin breathable film and/or adhesive layer(s) of a textile composite in order to inhibit the growth of odor causing bacteria or fungi. In addition, this invention relates to the addition of antimicrobial “actives” that when incorporated to the breathable film or adhesive layers, can deliver infection control properties to the composite.

It is known in the art that antimicrobial materials are useful in neutralizing or reducing the impact of bacterial growth. For example, the main purpose in adding antimicrobials or biocides in plastics was to protect the polymeric materials from deterioration and destruction from microbial attack. Some traditional antimicrobial agents are often actually preservatives, which while effective as antimicrobials are toxic to humans. Certain metals and more specifically the ions released from these metals have also proven effective as antimicrobial agents while also possessing a safe medical profile. From both a cost and safety viewpoint it is however advantageous to minimize the quantity of these metals and ions in use.

It is also well known that bacteria are found on all healthy skin, in soil and on the foods that we eat. Normally such bacteria are benign, but they can become problematic when exposed to a compromised or weakened immune system or allowed to grow and dominate the normal bacterial flora. Under these uncontrolled growth conditions, certain benign colonies become opportunistic and thrive in the compromised environment, often leading to spoilage, odors, infection, and food poisoning that sometimes lead to illness or even death. In this application as well, metallic based antimicrobial agents, in particular silver, have been well accepted as an infection-control technology in certain medical settings.

In a related field, consumer and professional awareness of spoilage, discoloration, infection and illness related to biological causes is broad. Bacteria, mold, and fungi colonies can be a primary cause of material degradation, discoloration and weakening. Additionally, many odors are generated directly by microbial growth or indirectly by toxins released by these microbes. The odors caused by the decomposition from these microbes can be noticeable and objectionable. Most people associate the odors of decomposition or rancidity with infection and unclean environments. Microbial growth has been linked in many studies to hospital acquired infections and hard to heal wounds. The link is therefore drawn between good smelling i.e. no odors, and healthy/clean materials.

For all of the above stated reasons, the use of antimicrobials in textiles is not new. The prior art has numerous examples wherein metal ions such as silver or other such “actives” have been either added into the master batch for the extrusion of synthetic fiber or are bonded to the surface of a synthetic or natural fiber. The resulting fiber can then be knitted or woven into a textile product or formed into a textile web through various non-woven manufacturing processes. One example of such prior art, wherein the surface of a fiber is externally covered with metallic silver via a plaiting process, is sold under the trade name X-static®. Fibers processed with this feature exhibit antimicrobial activity as the metallic silver oxidizes, thus textiles constructed from such fiber as a result have antimicrobial properties.

Other similar prior art involves the addition of the metallic antimicrobial “actives” to the polymer that will become the synthetic fiber during or prior to the extrusion process. The result of such a process is that the antimicrobial active is contained within the fiber itself and a degree of antimicrobial effectiveness can be observed. Additives from Milliken Chemical under the Alphasan name and also from AgION are advertised as suitable for use within the polymer of a textile fiber. Milliken packages silver ions in a zirconium structure while AgION uses a zeolite structure. Both react by releasing the Ag⁺ ions when they encounter negative ions while in a wet or moist environment. Similarly, Ishizuka manufactures several grades of silver loaded glass particles that simply dissolve at different rates in fluid. As they dissolve, entrapped metallic ions are released. In addition, NanoHorizons and others manufacture very small particles, nano sized particles, of many materials including metallic silver, zinc and copper. Within these nano-particles, typical sizes of 20-80 nanometers are observed. All of the above are commercially available products and are promoted for use as polymer additives in plastics, coatings, fibers and films. The difficulty is that one of the well-recognized limitations of placing antimicrobial ‘actives” within the structure of a fiber is that the only those particles in direct contact with an exterior surface are utilized. Interior particles are not effectively utilized and this is therefore not cost-effective technique. It is of note though that all of the above have been evaluated and found useful in connection with the present invention.

It is important to note that the above group of products have only been made available relatively recently within the past two to ten years. Prior to the introduction of these metallic based antimicrobial agents, formulators used a wide variety of silver, zinc and/or copper containing compounds, oxides, salts, colloids, proteins and other chemicals. The list is broad and includes but is not limited to: silver acetate, silver azide, silver bromide, silver bromate, silver carbonate, silver carbamate, silver chloride, silver chlorate, silver chlorite, silver chromate, silver fulminate, silver halide, silver cyanide, silver dichromate, silver fluoride, silver iodate, silver iodide, silver molybdate, silver nitrate, silver permanganate, silver perchlorate, silver subfluoride, silver sulfadiazine, silver sulfate, silver sulfite, silver telluride, silver (I) chlorate, silver (I) cyanide, silver (I) fluoride, silver (I) oxide, silver (I) selenium, silver (I) fluoride, silver (II) oxide. Additionally, it is important to list the naturally occurring and biocompatible silver alginate. Several versions of colloidal silver are also known. Further, there are similar lists for copper and zinc that are not listed here for brevity.

It has been noted that when exposed to metals and metallic ions, in addition to microbes, algae, bacteria, mold, yeast, fungi and viruses are all denatured. There are several theories surrounding this observation, most involve the attachment to or penetration of the cell wall by the metallic ions and either killing of the cell or prevention of reproduction. Silver in particular, forms strong bonds or ligands with sulfur containing materials, proteins in this case, and disrupts cell activity. Similarly, this antimicrobial effect is shown by ions of: mercury, copper, iron, lead, zinc, bismuth, gold, aluminum and other metals. Toxicity and/or bioaccumulation is observed with several of these metals, however, silver, zinc and copper are recognized as having little or no toxic effects on mammals.

To eliminate the ineffectiveness noted above with the placement of “actives” within the core of a fiber, bicomponent fibers can be constructed, especially core/sheath designs. When the antimicrobial “active” particles are placed within the exterior sheath, the problem of not utilizing the expensive ‘actives” in the core is eliminated. It is observed however that there are a very limited number of vendors manufacturing fibers constructed using the expensive bicomponent manufacturing process and remains a costly specialty product. It is also possible to apply a coating to the surface of a fabric and thus the fibers of the fabric. There are many coatings ranging from acrylic to fluorocarbon that are sold for this purpose and with careful processing, an antimicrobial ‘active” can be incorporated such coatings. However, severe problems are often encountered with this technique including a lack of durability, difficulty in obtaining a uniform coating, color changes over time and in sunlight and limited performance related to a limited quantity of coating add-on. It can be fairly stated that because of these limitations, surface coatings are considered semi-durable and are not well accepted in most fabric/apparel applications.

While there are a number of antimicrobial fibers and textiles that have been made using these prior art methodologies, both the in-fiber and coated-fiber methodologies have their significant disadvantages. Because both methods involve very expensive metal ion additives to custom fibers, they add very significant expense to the finished product. The expense of the additives and the volumes involved in these products necessitate small production runs. In addition, the small production runs of fiber are then used to construct small production runs of textile web. The result is a significant work loss at each step of the manufacturing process, as well as a significant cost mark-up at each stage. The resulting antimicrobial fabrics can cost many times what a conventional fabric would cost. In addition, anyone who desires to use one of these antimicrobial fabrics in a product is restricted to a very small selection of available styles and colors, or alternatively is forced to bear the expense of creating their own custom textile. Both the significant additional costs and the lack of off-the-shelf fabric styles have the effect of vastly limiting the potential use for antimicrobials in textiles.

There are other disadvantages to some of this prior art as well. For example, the X-static® covered fibers can be coarse to the touch due to the fact that the surface of the fibers has been significantly impacted by the silver plating adhered to the surface. These fibers also have a specific appearance color that may or may not be desirable in all applications. Additionally, the metallic silver is both electrically and thermally conductive. While certain conditions may exist where a conductive textile can be advantageous, generally conductivity is a disadvantage.

Other prior art attempts at creating antimicrobial fibers have been directed at incorporating silver within fiber without affecting the fiber properties as significantly. One such product involves the incorporation of a nanoparticles of silver into fibers and sold under the trade names of E-47 and SmartSilver® nano manufactured by NanoHorizons. Due to the small particle size of the nano silver, there is a much less significant effect on the fiber characteristics. This process, however, still leaves a large amount of the expensive nanoparticles embedded within the fiber where they can do no good from an antimicrobial standpoint. Since the nanoparticles are even more expensive per pound than standard formulations, the use of such particles does nothing to eliminate the other disadvantages of fiber based technology noted above. Accordingly, textiles incorporating nanoparticles of metal actives still bear a very high cost premium and also restrict the consumer to a small range of available products.

In an attempt to deal with the limitations of adding antimicrobial actives to the fibers themselves, other prior art solutions tried to provide the antimicrobial actives as an add-on to the textile or fiber. Examples of such add on methods of applying antimicrobial actives to textiles include specially formulated sprays or other post-treatments. One such product is marketed for use in hunting apparel under the trade name Xtreme Scents Silver XP. The product contains silver ions in suspension and is available as a spray and also a laundry detergent. In the case of the spray, the consumers can take an otherwise non-antimicrobial textile garment and apply the silver to it themselves. Similarly, the laundry detergent would apply the silver in the wash. One can imagine that a spray or wash application is the least durable application method and is suitable only for certain applications. Although the existence of such consumer post-treatment silver containing sprays and detergents highlights the consumers desire for obtaining antimicrobial properties in a wider range of textile products and at a reasonable cost. The lack of durability and accuracy in the post-treatment add-on products is, however, a significant disadvantage for the consumer.

Alternately, there exists in the prior art antimicrobial actives in the form of polymer films. In this regard, most polymer films are manufactured for their barrier or packaging properties. Moisture transmission on food packaging or barrier films is generally viewed as a negative, as such films are by design produced to contain fluids or solids or to reduce exposure of packaged items from the environment. Such films are often used in food packaging applications for food or water storage. Films placed in such end uses are frequently exposed to bacterial, mold and fungi and they can be subject to degradation, discoloration and odors under certain conditions. Not surprisingly, then, there are numerous examples in the prior art of antimicrobial actives added to such films. One such example would be the use of relatively thick polyurethane films of greater than 0.004″ or 100μ that have been marketed for use in hydration systems under the Camelbak® brand. Antimicrobial silver is utilized within the film to control bacterial growth on the inner wall of the hydration bag. The growth, often called a bio-film, can cause a foul taste to the stored liquid. This type of film would not incorporate the properties of moisture transmission, elasticity, flexibility and thinness described in the present invention and as a result, would not allow the creation of the layered antimicrobial textiles contemplated by the present invention.

Films need not be solid structures. Alternately, they can be perforated via a variety of techniques and can be transformed into nets. Perforation may be accomplished via ultrasonic energy, hot or cold pins or needles, mechanical embossing followed by stretching, high pressure water or air and laser beams. When a perforated film is stretched such that the holes enlarge, it is sometimes considered a net or netting. Perforated films are often used when increased airflow is desired. Breathable polymers and breathable films allow moisture transport and limited gas flow but do not offer sufficient porosity for certain applications. Wound dressings and outdoor jackets are two such applications. Further, any film, breathable film, perforated film or film netting can be multi-layered. By constructing the film with an A/B structure, a low melt side can be incorporated to allow thermal bonding to one side of the film. If an A/B/A or A/B/C structure is used, a low melt bonding surface can be utilized on the two exterior surfaces for dual side bonding while maintaining the integrity of the interior film. While discussing a low melt bonding surface, it must be mentioned that this ability can also be imparted by coating, printing or depositing a bonding layer onto the film surface(s). Perforated films and film nets also can be used as release or non-adherent surfaces. Generally, this is desired where minimizing friction is important or specifically in the case of a wound dressing, where ingrowth of cells and tissue needs to be minimized. In general, while antimicrobial actives have been used in film structures, none of this prior art anticipates the novel aspects and synergies of the present invention. None of the prior art involves the creation of such desirable textile composites that can be utilized for clothing, linings, upholstery etc. None of the prior art teaches the novel methods of creating an antimicrobial textile described herein.

### BRIEF SUMMARY OF THE INVENTION

In this regard, the present invention provides for a novel method of incorporating antimicrobial actives within a textile. Instead of adding these materials to fibers, or adding them as a post-treatment to a textile, the present invention involves the creation of a breathable thin elastic layer containing antimicrobial actives that is bonded as a layer within a textile composite. The addition of the antimicrobial within a breathable flexible elastic film or a netting layer eliminates many of the disadvantages of the prior art. A single antimicrobial breathable film or netting product may be utilized with a nearly limitless array of available textiles. The breathable film or netting is extremely thin, and thus the amount of additive can be small, and yet concentrated in the specific area where it will do the most good.

A film layer containing the antimicrobial actives can be constructed from moisture transmittable material that greatly enhances the functionality of the actives. This moisture transmittable film, while allowing sweat as moisture vapor to pass through, can also serve as a barrier to debris and bodily waste products that would otherwise fall into the other textile layers and act as further food for bacterial growth. Both films and properly designed nettings are durable and the useful life of the composite is substantial. There are thus advantageous synergies created by the incorporation of antimicrobials additives in such a breathable film or netting layer.

In addition to novel textile constructions for the delivery of antimicrobial actives, the present invention also describes novel formulations to be used within the film or netting layer to provide for enhanced antimicrobial, odor-control and infection-control properties.

Accordingly, the various features of novelty that characterize the invention are pointed out with particularity in the claims annexed hereto and forming a part of this disclosure. For a better understanding of the invention, its operating advantages and the specific objects attained by its uses, reference should be had to the accompanying drawings and descriptive matter in which there is illustrated a preferred embodiment of the invention.

### BRIEF DESCRIPTION OF THE DRAWINGS

In the drawings which illustrate the best mode presently contemplated for carrying out the present invention:

FIG. 1A is an illustration of a breathable fabric/film/fabric composite using the film of the present invention;

FIG. 1B is an illustration of a breathable fabric/film/foam composite using the film of the present invention; and

FIG. 1C is an illustration of netting according to the teachings of the present invention used in a composite.

### DETAILED DESCRIPTION OF THE INVENTION

The present invention provides a polymer additive composed of one or more metallic ion releasing materials which, when blended into the matrix of a breathable film, provides antimicrobial and odor-control performance when utilized in a laminate or composite structure. These waterproof breathable films, coatings, apertured films or film/nets made with combinations of silver, zinc and/or copper ion-releasing “actives” offer microbial and odor-control properties. Via blending of multiple “active” components and formula optimization, both fast acting and long lasting performance has been observed. An additional advantage of this blending is the ability to utilize low levels of silver, zinc and or copper containing materials while maintaining effectiveness and thus improving the safety profile of these laminations. Yet another advantage of the teachings of the present invention is the ability to reduce costs and allow short production runs of composites via the inclusion of the odor-controlling materials in the film or adhesive as compared to the fibers of surface coatings as currently practiced.

In the context of the present invention the following terms will be utilized as defined below, wherein:

The term “antimicrobial” refers to a substance that kills or inhibits the growth of microbes such as bacteria, fungi, viruses, or parasites.

The term “antimicrobial metal” refers to a metal, metal alloy, or metal composition comprising one or more metals that inhibits, prevents, or reduces the growth or reproduction of a microbe. Silver, copper and zinc are included in this group.

The term “microbe” refers to a microscopic life forms including, but not limited to bacteria, fungi, RNA or DNA viruses, prions, mycoplasma, and single-cell organisms or parasites and biofilms.

The term “active” refers to a material that provides or imparts antimicrobial or odor control functionality to another material or substrate. Common examples included silver copper, zinc metals or metallic ions for microbial control. By virtue of microbial control, these “actives” impart both odor and infection control properties.

The term “fabric” refers to a flexible fibrous structure. This structure includes, but is not limited to a substrate made by weaving, felting, knitting, crocheting, or a combination thereof, natural or synthetic fibers. The term includes compressed matted animal fibers, natural fibers, synthetic fibers, or a combination thereof.

As used herein, the terms “fiber” or “fibers”, “foam” or “foams” are interchangeable. Though the terms denote differently formed materials, where one of the terms is used, the other or the plural of either is intended.

The term “film” refers to coating on or within a surface that forms a continuous sheet, layer or surface. Additionally, “film” refers to a thin sheet of polymeric material that is flexible.

The term “breathable film” refers to a film that is very slightly permeable to gasses resulting from the presence of small openings or channels within the film, or through moisture vapor adsorption and desorption through the monolithic film layer in the case of hydrophilic films. This term includes films that are mechanically perforated or contain monolithic layers that are hydrophilic and allow gasses and or moisture to pass through. Breathable films are generally less than 100-microns thick and exhibit moisture breathability of greater than 100 g/m2/day when measured with ASTM method E-96 B at room temperature and 50% relative humidity.

The term “thickness” refers to a measurement of the dimension of a film between the two planar surfaces, is measured with a micrometer and reported in either thousandths of an inch, mils, microns or millionths of a meter. One thousandth of an inch (0.001″) equals 25.4 microns (μ). Commercial thickness measuring gauges obtained from Mitutoyo are typically used including the Digimatic series of tools.

The term “laminate” refers to a material constructed by uniting two or more layers together. The process of creating a laminate is lamination. The term “lamination” refers to process of sandwiching layers of materials and sealing them with adhesives, heat and/or pressure. Laminates are often called composites.

The term “composites” is defined as an engineered material made from two or more constituent materials with significantly different physical or chemical properties and which remain separate and distinct within the finished structure. In this case we are specifically referring to textile and foam flexible structures that contain a breathable film.

The term “nano” refers to the dimension of a material using a scale of 10⁻⁹. For example one nanometer (μm) is 1-meter×10-9 or 0.000,000,001 meters. Within this discussion, materials that are referred to as being “nano” in size are generally between 10 and 1000 nanometers in diameter or thickness.

In determining a film for use in the present invention, it can be appreciated that films made from conventional plastic polymers that are perforated or apertured to allow airflow are suitable. Polyethylene, polypropylene, nylon, polyester, etc are commonly used in films. Antimicrobial “actives”, when incorporated into the melt mix prior to extrusion or casting deliver odor-control and infection-control properties to the film. Via perforation or aperturing, the film is made breathable and when placed in a textile or foam laminate, both breathability and antimicrobial activity are imparted into the composite.

The use of certain noble or transition metals in metallic or ionic states is an accepted antimicrobial approach in many plastics and coatings. Silver, Zinc and/or Copper are offered commercially for use in plastics including; metallic plating, zeolite and zirconium matrices, colloidal suspensions and nano-particulates, silver salts in solid or dissolved formats and others. Each metallic system exhibits a certain speed and rate of ionic release profile which is rather inflexible and is largely surface-area driven. An example is when silver oxidizes or tarnishes thereby releasing antimicrobial Ag⁺ ions when exposed to ozone, hydrogen sulfide, or air containing sulfur. Further, each species or version of a metal containing “active” performs in a specific manner. This performance is measured via elution or release of silver, copper or zinc ions into the local environment. This elution is what comprises the basic antimicrobial activity and without elution of metallic ions, there is no beneficial effect. The elution is governed by many factors including but not limited to surface area, dissolution speed, and construction of the particle i.e., zeolite “cage” or solid metallic particle for example.

Through exhaustive and detailed evaluation, the performance characteristics of many antimicrobial “actives” have been determined. Both good and undesirable properties of these ‘actives’ were determined. It is then possible to identify the desired rate-of-release, or elution, properties and via blending or compounding of multiple “actives” obtain an optimized solution. This optimization can take into account many factors strictly depending on the final product and desired performance. The overall cost, speed of ionic release, duration of ionic release, color change properties, particle size and the ratio of ions of multiple metals are therefore within the control of the formulator. Remarkable results have been obtained via this investigative process.

Metallic silver, zinc and/or copper can be utilized as a film, coating or plating. When metals are applied in a film, they obviously do not allow gas, vapor or moisture flow and are not suitable in a breathable composite. They are also expensive when utilized in this manner simply due to the high material costs involved. These metals can also be purchased in particle or power format and can be loaded into zeolite and ceramic structures that act as slow release mechanisms. These metal-containing particles are typically 3 to 40 microns in diameter and are suitable for plastic injection molding when incorporated into thick films (over 0.004″ or 100μ) but are not compatible with thin films simply because of their large particle size.

Consider a thin breathable film with a thickness of 5 to 15μ. A particle of commercially available silver antimicrobial is relatively large in comparison to the film thickness and therefore problematic as it reduces strength and durability and can easily pinhole the film. Additionally these powders tend to agglomerate or clump and are often much larger in size than individual particles. Uniformity of distribution of the “actives” is a significant problem. Additionally, when thin films are manufactured, the small openings of the die can be plugged with these agglomerations.

The present invention involves the incorporation of metal actives within extremely thin breathable film layers to allow for their use within flexible breathable textile composite structures. There are a number of critical features to the present invention that differentiate it from any prior art. Most specifically, the present incorporates breathable polymers in the extrusion of the film containing the actives. We have demonstrated that in order to function within the present invention, such polymers should preferably exhibit moisture transmission rates of at least 100 g/m2/24-hrs when tested in accordance with ASTM E96-B at room temperature and 50% relative humidity and more preferably moisture transmission rates of at least 200g/m2/24-hrs.

Appropriate polymers for use in thermoplastic breathable film include but are not limited to the following: Thermoplastic Polyurethanes (TPU) (BASF Elastollan®; Noveon Estane®; Dow Pellathane®; Marquina; Skythane®; Huntsman Irogran®); Ether-Amides (Arkema Pebax®); Block Copolyesters (Dupont Hytrel®; DSM Arnitel®).

Appropriate polymers used in conventional films supplied by DelStar Technologies Inc., Middletown Del., and Smith & Nephew Extruded Films, Gilberdyke, England, that will be perforated or apertured include; but are not limited to, the following: Polyolefin's in general and more specifically polyethylene homopolymer of copolymers in low density (LDPE), linear low density (LLDPE), medium density (MDPE), high density (HDPE), to a lesser degree ultra high density (UHDPE) formats generally from Dow Chemical, BASF, Basell, DuPont, Exxon Mobile, Nova Chemical, Union Carbide and many other suppliers; Polyolefin's in the polypropylene family from many suppliers including; Basell, Phillips 66, Eastman Chemical, Union Carbide, Amoco and Fina Chemical; and Polyamides typically known as nylons in many chemical versions including but not limited to 6, 4/6, 6/6, 6/12, 11 and 12 from; Arkema, BASF, DSM, DuPont, ICI, Solutia and EMS and many other suppliers.

Elasticity of the extruded film is also important. It is desirable for the film layer to have an elasticity of >100% per ASTM method ASTM D-412 for the thermoplastic elastomers above while for polyolefin netting, >25% is useful. If the needs for strength, elasticity are breathability are balanced, it is determined that the ideal film thickness will be between 3 and 60 micron, and more specifically within the range of 5-40 micron. A highly desirable range for such a film would be between 5 and 20 micron.

A synergistic effect is observed in this invention. The breathable films are typically either porous by nature or hydrophilic or both porous and hydrophilic. Both of these properties promote moisture transport through the thickness of the film. Moisture transport is also enhanced with the selection of one or more textile or foam layers that utilize hydrophilic/hydrophobic chemistry and/or cross sectional modifications to promote moisture transport. Both properties, breathable plus moisture transport are synonymous, and assist in the generation and release of ions from metallic particles of silver, copper, zinc, etc. When this breathable film is then joined to adjacent fabric and/or foam layers in a composite, the antimicrobial and odor-control properties of the breathable film are transferred to the adjacent fabric/foam layers by virtue of the very close physical proximity of the layers and materials. This is a novel approach to odor-control in a composite and one that offers increased performance and reduces costs. An additional synergy relates to the films ability to block the entrance of debris and bodily waste products into the remainder of the textile. Such debris can serve as food for bacteria growth, and thus the incorporation of the silver within the breathable film layer provides this additional synergy.

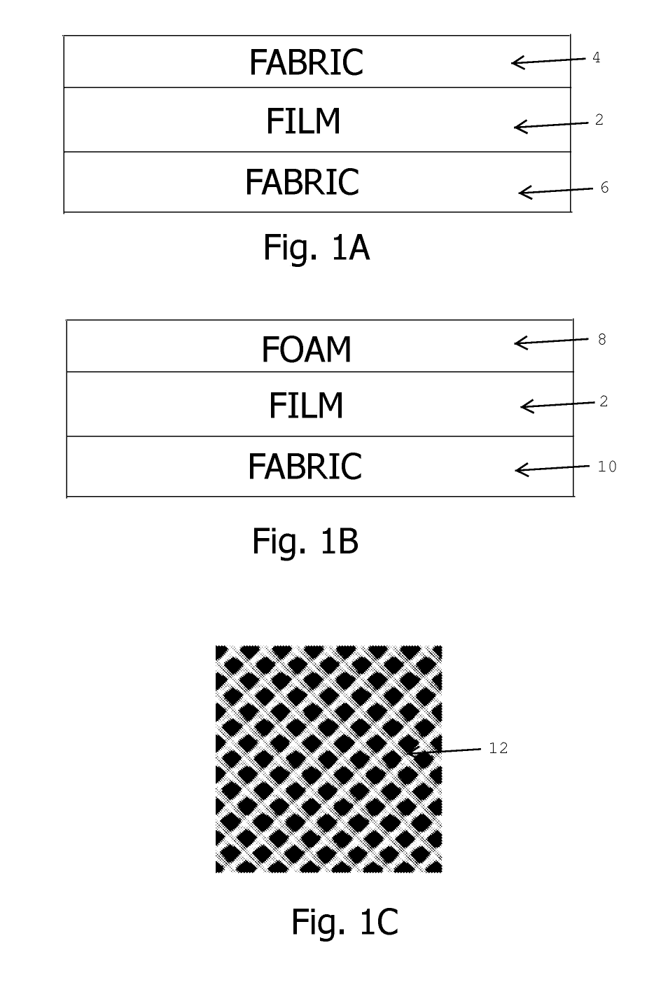

The present invention provides a breathable film incorporating a metallic based antimicrobial and odor-control “active” component. The preferred “active” contains silver, zinc and/or copper ions. The preferred film utilizes monolithic or microporous polymers, additives or mechanical processes to impart breathability. This combination of breathability plus antimicrobial and odor-control properties is both unique and desirable in many applications. Turning to the figures, the film 2 of the present invention can be combined with one or more textile or foam layers to form a composite. For example, FIG. 1A illustrates the film 2 disposed between an upper fabric layer 4 and a lower fabric layer 6. In FIG. 1B, the film 2 is shown positioned between an upper foam layer 8 and a lower fabric layer 10. Alternately, the lower fabric layer 10 in some embodiments may also be foam. Finally, FIG. 1C depicts the film as a netting 12 formed in accordance with the teachings of the present invention. In this regard, the odor control properties of the film 2 are transported to the adjacent layers and thereby improve the odor control performance of the entire structure, lamination or composite. In essence, the odor control features of the film 2 extends to the adjacent layers.

The presence of moisture or moisture vapor allows these ions to be released, transported and generally made available. One can imagine how a solid plastic including films and fibers trap antimicrobial “actives” within the structure and away from the surface. This effectively makes them unavailable and ineffective. If that plastic is substituted with a film that is a porous, breathable and/or contains a hydrophilic polymer, then moisture vapor slowly penetrates into and throughout the depth of the film contacting the metallic antimicrobials and releasing ions. The rate of release is dramatically improved and odor-control performance increased in addition to improved comfort from the moisture releasing properties of the composite.

Moisture is effective in at least two modes. First, moisture assists in microbial movement by conveying the bacteria to the active materials especially in a breathable composite. Second, moisture actively promotes the generation and release of metallic ions and their resultant antimicrobial properties. A synergistic effect is observed in this invention. The breathable films are porous by nature or are often hydrophilic or both porous and hydrophilic and thus promote moisture transport. Moisture transport is also enhanced with the selection of one or more textile or foam layers that utilize hydrophilic/hydrophobic chemistry and/or cross sectional modifications to promote moisture transport. Both properties, breathable plus moisture transport, assist in the generation and release of ions from metallic particles of gold, silver, copper, zinc, etc. When this breathable film is then adhered or joined to adjacent fabric and/or foam layers, the antimicrobial and odor-control properties of the breathable film are transferred to the adjacent fabric/foam layers. This is a novel approach to odor-control in a composite and one that offers increased performance and reduces costs.

Breathable films are constructed using one of several techniques. Polymers can be dissolved or dispersed in a solvent, spread onto a thin film and dried. This thin film can be applied directly onto a casting paper, film or other disposable surface or can be applied directly onto the textile or foam of the final composite. Often, the casting film is required to mechanically stabilize the thin film web in downstream and post processing. If a solvent is utilized, it can be hydrocarbon, alcohol or aqueous based depending on the polymer being dispersed. This is generally viewed as the most expensive and environmentally harmful alternative.

Breathable films can also be blown or forced through a circular die under high pressure, often with the use of processing aids such as lubricants. Blown films offer the potential for cost reduction based on speed but also rely on the assistance of the processing aids so the film layers do not stick or block. Not all polymers are easily processed with this technique and very thin films are generally not possible. A modification of this is the casting of a flat sheet from a slot extrusion die, also under high pressure, but generally without the need for any additives or processing aids. The film generated with this technique can be quite thin and uniform and offer very good flexibility or hand while providing acceptable barrier properties for airflow and water penetration in the final application.

Yet another technique involves the preparation of a reactive coating on a casting sheet or directly to a substrate and then allowing that coating to crosslink and form chemical bonds between adjacent monomer/polymer components within the coating or film. Generally energy and a cross-linking promoter or initiator is applied to promote this cross-linking step. Ultraviolet energy, gamma radiation, heat, moisture or high voltage exposure is applied to complete the cross linking process. The advantage of this process is the added physical performance imparted into the film or coating as the chemical bonding or cross-linking occurs. High speeds and very low costs are possible and this process is replacing some applications previously performed with solvent coating.

The breathable films described above are generally single layered however it can be advantageous to make multilayer films or film composites to enhance properties. If the film is formed from a liquid coating, this coating can be applied multiple times or in stages using different polymers, additives or thicknesses. If the film is formed via extrusion and a die, the die can be fabricated to allow multiple layers that are extruded at the same time using different ray materials and feeding systems. Additionally, if the film is formed from an extrusion and slot die, multiple dies or multiple passes or layering is possible. Finally, the gluing or lamination of individual films is also possible. The bonding can be accomplished with thermal chemical or ultrasonic energy to bond adjacent films in a pattern bonded or fully bonded format. One can see the wide variety of breathable films that can be produced and utilized within this invention.

Textile and/or foam composites can be held together using a range of adhesives applied using a number of techniques including 100% solids hot melt, hot melt powder paste or dot dispersions, acrylic, rubber or synthetic block copolymers carried in a solvent or aqueous dispersion, or such composites can be combined using flame lamination or any other lamination or bonding method known to one skilled in the art. When an adhesive is utilized, it can be applied in a continuous or discontinuous pattern. Some materials can be joined with the simple use of heat and pressure. It is possible to select a film that acts as bonding substrate and with the application of heat and pressure, partially melts to achieve bonding with adjacent layer(s). Point bonding can be achieved with a pattern using heat/pressure or ultrasonic energy. Flame lamination is another approach that is frequently used with foams. When a high degree of breathability is desired, a perforated film or net can be utilized.

Uses and applications for the layered antimicrobial textile described in the present invention include but are not at all limited to the following areas: clothing such as active-wear, hunting apparel, military clothing, protective clothing, footwear, braces, helmet linings, protective sports equipment and padding, equestrian clothing and devices, tenting, bedding, upholstery fabrics, automotive interiors, medical fabrics, underpads, skin wraps, wound dressings, camping products, toys, tenting and industrial fabrics of all kinds. The above list is meant to be illustrative and in no way limits the contemplated uses for the present invention but are merely listed as examples.

### EXAMPLE 1

Polyether-type thermoplastic urethane (TPU) film was made via melt processing and slot die extrusion. The polymer was Estane® 5714 sourced from Noveon, Cleveland Ohio and was dried prior to use to remove accumulated moisture. The film thickness ranged from 15 to 25 microns and for stability and processing ease, was cast onto a polyethylene liner with a finished width of 60″. Those familiar with film extrusion will recognize this as a standard process and thus the details are omitted. This is a typical fabric coating TPU and was modified with the addition of a silver/zinc antimicrobial agent equal to 1.0% of the total film weight. This “Masterbatch” was then added at the 5% level in the final process. The ultimate concentration of antimicrobial actives in the film was therefore 1.0% by weight. For an “active” AirQual Z200 sourced from ACT in Canton Mass. and is the product formerly sold under the DuPont MicroFree name was selected. To insure uniform dispersion, the “active” antimicrobial was mixed at 20% with Estane® 5714 in a masterbatch process. This film was used as a layer in a fabric composite where waterproof and breathability properties were desired.

### EXAMPLE 2

The master batch described in Example 1 was blended at the 5% level with 95% Elastollan® SP806-10, a polyether-type thermoplastic polyurethane (TPU) sourced from BASF, Wyandotte Mich. This mix was dried, melt processed and extrusion cast via a slot die at 62″ onto 2.0 mil polyethylene carrier with a 12 to 25 micron film thickness. This film was used as the external layer of a gel pad for use in footwear. The gel was a two-part reactive urethane mix with a low durometer and a permanent soft feel. In this composite, the antimicrobial and odor-control properties of the TPU film effectively impart efficacy to the entire film-covered surfaces of the gel pad.

### EXAMPLE 3

The master batch described in Example 1 was blended at the 5% level with 95% Hytrel 8206, a specialty grade of block copolymer thermoplastic polyester elastomer sourced from DuPont, Wilmington Del. This formula was dried, melt processed and extrusion cast via a slot die at 62″ on 1.5 mil polyethylene carrier. The resultant very thin film was between 5 and 50 microns in thickness. Using conventional lamination techniques, this film was joined to various fabrics including camouflage pattern tricot knits and a Thinsulate® insulating layer from 3M. This is a typical fabric composite used for hunting apparel and jackets. The antimicrobial and odor-control performance of the “active” in the film is effectively imparted to the entire composite during real-life usage.

### EXAMPLE 4

Blown TPU film was made on a circular die following melt processing. A typical package of lubricants, anti-static agents, and waxes was added to allow processing without sticking or blocking. These “processing aids” are well known to those skilled in the art and will not be listed here. The same master batch described in Example 1 was blended with a combination of breathable TPU resins at a 1.8% loading rate by weight. The blown film was between 18 and 30 microns thick and was used in a fabric and insulation composite similar to what is described in Example 3. This film was additionally tested successfully in a fleece (brushed knit) to fleece composite for outerwear.

### EXAMPLE 5

A master batch was made using a blend of silvers including Alphasan from Milliken Chemical, Spartanburg S.C., AJ10D from AgION Technologies, Wakefield Mass. and lonpure from Ishizuka Glass Company, Japan. An extrusion grade of polyolefin was used in both the master batch and the final film extrusion. Typical melt spinning technology including a slot die was followed by embossing the film in a pattern to allow perforation when stretched in the machine and cross-machine directions. This process is known to those skilled in the art of making netting or apertured films. The resultant net contained “active” metallic antimicrobials either throughout the film thickness or only on one side of the film when cast as a co-extrusion. This net was used to join two fabric layers together for a composite similar to those used in apparel or footwear linings.

### EXAMPLE 6

The net described in Example 5 was thermally applied to a hydrophilic nonwoven fabric for use as a wound dressing. The netting acts as a non-adherent layer against the skin in this design. The composite was tested for antimicrobial activity and the found to be effective against bacteria normally found on the skin and also associated with wounds and infections.

It can therefore be seen that the present invention provides a novel method of incorporating antimicrobial actives within a textile whereby breathable thin elastic layer containing antimicrobial actives is formed that is bonded as a layer within a textile composite. The addition of the antimicrobial within a breathable flexible elastic film or a netting layer eliminates many of the disadvantages of the prior art. Accordingly, a single antimicrobial breathable film or netting product may be utilized with a nearly limitless array of available textiles. For these reasons, the instant invention is believed to represent a significant advancement in the art, which has substantial commercial merit.

While there is shown and described herein certain specific structure embodying the invention, it will be manifest to those skilled in the art that various modifications and rearrangements of the parts may be made without departing from the spirit and scope of the underlying inventive concept and that the same is not limited to the particular forms herein shown and described except insofar as indicated by the scope of the appended claims.

What is claimed:

1. An antimicrobial polymeric film, comprising:
a polymeric film; and
at least one metallic antimicrobial active contained within said polymeric film;
wherein said polymeric film has a moisture vapor transmission rate in excess of 100 g/m2/24 hr and a thickness of less than 50 microns.

2. The polymeric film of claim 1, wherein said film is formed from a material selected from the group consisting of: thermoplastic polyurethane, Block Copolyester, Ether Amides and blends thereof.

3. The polymeric film of claim 1, wherein the film thickness is less than 25 microns.

4. The polymeric film of claim 1, wherein the film thickness is less than 15 microns.

5. The polymeric film of claim 1, wherein the moisture vapor transmission rate is over 200 g/m2/24 hr.

6. The polymeric film of claim 1, wherein the antimicrobial actives are selected from the group consisting of: metallic silver, metallic zinc, metallic copper, glass silver actives and combinations thereof.

7. The polymeric film of claim 6, wherein the antimicrobial actives are metallic nanoparticles.

8. The polymeric film of claim 1, wherein the film is formed using a method selected from the group consisting of: thermoplastic casting, thermoplastic casting onto a carrier sheet, and thermoplastic blowing.

9. The polymeric film of claim 1, wherein the film contains at least two different antimicrobial actives, each having a different antimicrobial effect.

10. The polymeric film of claim 9, wherein a first of said antimicrobial actives is fast acting and a second of said antimicrobial actives is a slower acting longer lasting active.

11. The polymeric film in claim 1, wherein the film is elastic.

12. The polymeric film of claim 1, wherein the film is hydrophilic.

13. The polymeric film of claim 1, wherein the film is layer is monolithic.

14. The polymeric film of claim 1, wherein the film transmits moisture by virtue of a plurality of small apertures therein.

15. The polymeric film of claim 14, wherein the apertures in said film are formed in the film using a method selected from the group consisting of: perforating, slitting, extruding said film as a net structure and extruding said film as a web structure.

16. The polymeric film of claim 14, wherein the film is composed of multiple layers of at least two different polymers.

17. The polymeric web of claim 16, wherein one of the polymeric layers is of a lower melting material to act a thermoplastic adhesive.

18. A composite antimicrobial textile, comprising:
a base fabric layer; and
a polymeric film layer bonded to the base layer and containing metallic antimicrobial actives, wherein such polymeric film layer has a moisture transmission rate in excess of 100 g/m2/24 hr and a thickness of less than 50 microns.

19. The composite of claim 18, wherein said film is formed from a material selected from the group consisting of: thermoplastic polyurethane, Block Copolyester, Ether Amides and blends thereof.

20. The composite of claim 18, wherein the film thickness is less than 25 microns.

21. The composite of claim 18, wherein the film thickness is less than 15 microns.

22. The composite of claim 18, wherein the moisture vapor transmission rate is over 200 g/m2/24 hr.

23. The composite of claim 18, wherein the antimicrobial actives are selected from the group consisting of: metallic silver, metallic zinc, metallic copper, glass silver actives and combinations thereof.

24. The composite of claim 18, wherein the antimicrobial actives are metallic nanoparticles.

25. The composite of claim 18, wherein the film is formed prior to bonding to said base layer using a method selected from the group consisting of: thermoplastic casting, thermoplastic casting onto a carrier sheet, and thermoplastic blowing.

26. The composite of claim 18, wherein the film contains at least two different antimicrobial actives, each having a different antimicrobial effect.

27. The composite of claim 26, wherein a first of said antimicrobial actives is fast acting and a second of said antimicrobial actives is a slower acting longer lasting active.

28. The composite of claim 18, wherein the film is elastic.

29. The composite of claim 18, wherein the film is hydrophilic.

30. The composite of claim 18, wherein the film is layer is monolithic.

31. The composite of claim 18, wherein said base fabric layer is formed using a material selected from the group consisting of: knitted, woven, nonwoven and foam.

32. The composite of claim 18, further comprising:
a second fabric layer bonded to said polymer film wherein said polymer film resides between said base fabric layer and said second fabric layer.

33. The composite of claim 32, wherein said base and second fabric layers are formed using a material selected from the group consisting of: knitted, woven, nonwoven and foam.

34. The composite of claim 18, wherein the film transmits moisture by virtue of a plurality of small apertures therein.

35. The composite of claim 34, wherein the apertures in said film are formed in the film using a method selected from the group consisting of: perforating, slitting, extruding said film as a net structure and extruding said film as a web structure.

36. The composite of claim 34,wherein the film is composed of multiple layers of at least two different polymers.

37. The composite of claim 36, wherein one of the polymeric layers is of a lower melting material to act a thermoplastic adhesive.
